(19) United States
(12) Patent Application Publication
(10) Pub. No.: US 2015/0181031 A1
(43) Pub. Date: Jun. 25, 2015

(54) INITIATING A VOIP CALL WITH CALLER SELECTED AUDIO

(71) Applicant: Pink Stone LLC, Mesa, AZ (US)

(72) Inventor: Christopher Warnack, Mesa, AZ (US)

(21) Appl. No.: 14/513,186

(22) Filed: Oct. 13, 2014

Related U.S. Application Data
(60) Provisional application No. 61/919,562, filed on Dec. 20, 2013.

(51) Int. Cl. H04M 3/42; H04M 19/04; H04L 29/06; H04M 7/00; H04M 3/436

(52) U.S. Cl. CPC H04M 3/42059; H04M 7/0033; H04M 3/436; H04L 65/4069; H04L 65/1096; H04M 19/041

(57) ABSTRACT

Methods and systems for caller selected ringtones are described herein. A method for Voice Over Internet Protocol (VOIP) call initiation includes receiving a connection request from a caller app on a caller device. The connection request includes a recipient identifier and an audio identifier, and may also include text and an image. A call initiation request is sent to a recipient app on a recipient device, the call initiation request including a caller identifier, including streaming audio corresponding to the audio identifier to the recipient device to cause the recipient app on the recipient device to play the streaming audio and to concurrently display a user name corresponding to the caller identifier. The recipient may then accept or reject the VOIP call.

### RELATED APPLICATION INFORMATION

This patent application claims priority from Provisional Patent Application No. 61/919,562 filed Dec. 20, 2013 which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND

1. Field

The disclosure relates to mobile device Voice Over Internet Protocol (VOIP) call initiation.

2. Description of the Related Art

Mobile telephones are ubiquitous in our society. When a mobile phone caller places a call to a recipient, the recipient's mobile telephone rings, playing audio selected by the recipient. This may be a recipient selected ringtone or music file from the recipient's device. Caller identification information such as the name of the caller may be displayed by the recipient's mobile phone according to information on the recipient phone by doing a number lookup in the recipient's mobile phone's address book. If a call originates from a plain old telephone system phone, the caller identification information may be passed to the recipient phone using Multiple Data Message Format (MDMF), Caller Identification Name (CNAM), Signalling System 7 (SS7), or other protocol.

The Internet and telephony areas have been integrated, and many mobile phone users have Voice Over Internet Protocol (VOIP) applications on their mobile devices. The VOIP applications on mobile telephones use a mobile data connection and/or WiFi to transmit and receive voice calls. Commercially available VOIP systems include SKYPE®, GOOGLE® HANGOUTS, VIBER® and LINE, for example.

Up until now, only a mobile phone recipient has been able to select the ring tone played when a call is received.

### DESCRIPTION OF THE DRAWINGS

FIG. 1 is a block diagram of a system topology.

FIG. 2 is a block diagram of a calling device environment.

FIG. 3 is a flow chart of a process of mobile communications initiation.

FIG. 4 is a mobile device screen shot showing a start screen interface.

FIG. 5 is a mobile device screen shot showing a contact list.

FIG. 6 is a mobile device screen shot showing a contact action interface.

FIG. 7 is a mobile device screen shot showing a first example an audio library interface.

FIG. 8 is a mobile device screen shot showing a second example audio library interface.

FIG. 9 is a mobile device screen shot showing a third example audio library interface.

FIG. 10 is a mobile device screen shot showing an audio record interface.

FIG. 11 is a mobile device screen shot showing an incoming call interface.

### DETAILED DESCRIPTION OF THE INVENTION

A method of mobile device communication initiation is described herein. In one version, the method enables a mobile device user to initiate a phone call with another mobile device user by specifying audio to be played on the recipient's mobile device. Simply, the method and system provide for caller selected ringtones.

Throughout this description, the embodiments and examples shown should be considered as exemplars, rather than limitations on the apparatus and methods described.

System

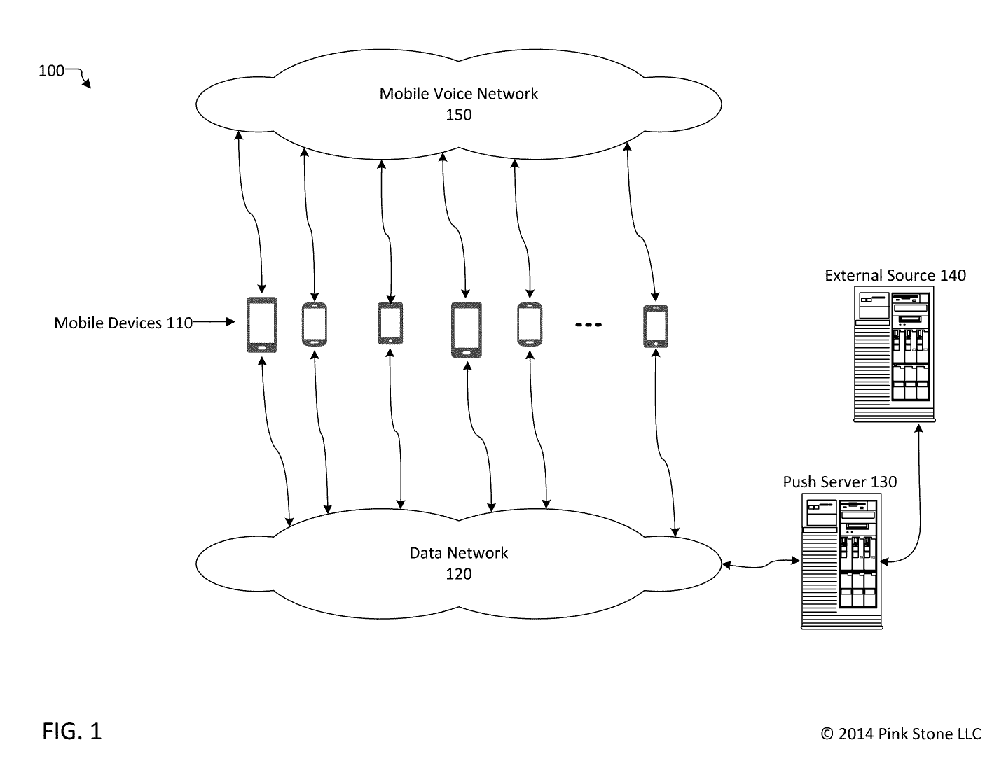

Referring now to FIG. 1 there is shown a block diagram of a system topology 100. The system topology 100 includes mobile devices 110, a data network 120, a push server 130, an external source 140, and a mobile voice network 150. The mobile devices 110 are cellular telephones and computing tablets. The mobile devices 110 have the ability to communicate via one or both of the data network 120 and mobile voice network 150. The methods and systems described herein require the mobile devices to be connected to and use the data network 120. The mobile devices 110 run an operating system such as, for example, ANDROID from Google Inc. and iOS from Apple Inc. The mobile devices 110 have a touch screen interface supported by the operating system for receiving user input and displaying information such as graphics and text to the user. The touch screen is used as both an input device and an output device. The mobile devices 110 include a processor and memory, such as, for example, random access memory (RAM), storage memory, and may include a graphics processor and/or an audio processor.

The mobile devices 110 include multiple hardware features. The hardware features include radios, transmitters, transceivers, antennas and electronic chips and firmware that enable the mobile devices to communicate over data network 120 and the mobile voice network 150. The hardware features also include one or more audio speakers to emit sound, one or microphones to capture sound, and one or more cameras to capture photographs and video. The operating system on the mobile devices provides software support to applications and enables the applications to access the hardware features of the mobile devices. Pertinent to the methods and systems described herein is that the operating system allows applications to access the audio speaker, the microphone, the storage memory, and the camera on the mobile devices.

The mobile devices 110 support voice and data communications according to multiple communications standards. Voice calls have historically been placed by connections to a cellular telephone network (such as the Global System for Mobile Communications (GSM) and code division multiple access (CDMA) networks) that is coupled with and communicates with other mobile devices and telephones over the public switched telephone network (PSTN). The mobile devices provide data communications capabilities using multiple protocols including, for example, General Packet Radio Service (GPRS), Enhanced Data rates for GSM Evolution (EDGE), High-Speed Downlink Packet Access (HSDPA), Dual Cell HSDPA (DC-HSDPA), High-Speed Uplink Packet Access (HSUPA), Universal Mobile Telecommunications System (UMTS), Wideband Code Division Multiple Access (WCDMA), Enhanced Voice-Data Optimized (Ev-DO), Long-Term Evolution (LTE), Time-division Long-Term Evolution (TD-LTE), Long-Term Evolution Time-Division Duplex (LTE TDD), and WiFi.

The data network 120 supports communications in various protocols (such as those named in the prior paragraph as well as others) over various media, including wired and wireless. The data network 120 is packet-switched and may comprise one or more public and/or private data networks, and other networks and sub-networks and may include or be the Internet.

The push server 130 and the external server 140 may be one or more servers that include a processor, memory, a communications interface (which may be one or more network interface cards (NICs) or devices) and storage devices. As used herein, storage devices are hard disk drives (HDDs) and silicon storage devices (SSDs) and include magnetic media and flash or solid state memory. The push server 130 runs an operating system, such as, for example, a version of the Microsoft Windows operating system, Linux, Unix, Apple MAC OS. Although only one each of push server 130 and the external source 140 are shown, the push server 130 and the external source 140 may be and may represent multiple servers. The push server 130 and the external source 140 may each be a group of servers, network capable storage devices, routers, switches, gateways and other communications devices. The push server 130 and the external source 140 may each be coupled with or communicate over data network 120.

The software that implements the methods described herein runs as push server software on push server 130 and as an app or application on the mobile devices 110. The push server software is stored on storage media included in or accessible to push server 130. The push server software may be distributed among multiple servers and other devices such as switches, gateways and routers. The mobile device app on the mobile devices 110 is stored on memory included in the mobile devices.

The push server software on the push server 130 also accesses software that supports VOIP calling. The software on push server 130 includes support for various communications protocols, including but not limited to SIP (session initiation protocol) Server, TCP, UDP, and support for soft switches, gateways, PBXs, and other similar communications software. The push server 130 also includes database software the push server software uses to manage registered users, and the audio files and image files pushed to users. In one embodiment, the database is implemented using MySQL.

The external source 140 stores audio files and image files. There may be multiple external sources. The external source, in one instance, is maintained by a music company or record company that is in the business of selling albums, CDs, music, ringtones and the like. Other external sources may provide images and may be a stock photo provider that provides photos of many kinds or greeting card company that provides postcard images. To implement the systems and methods described herein, the push server system has licensed the audio files and image files available from the external sources.

The push server software maintains a library of audio files and image files it makes accessible to users of the push app on mobile devices. The audio files stored in the push server 130 may be limited to a certain length such as 20 seconds, 30 second 45 seconds, 60 seconds, etc. to be used as a ring tone. The image files may be stored in various formats to accommodate the most popular mobile device screen resolutions, such as, for example, 640×960 pixels, 640×1136 pixels, 720×1280 pixels, 750×1334 pixels, 1080×1920 pixels, 1440×2560 pixels, etc. The push server software may regularly or occasionally update its library of audio files and images files by access the external source 140. The push server software does this to keep the audio files in its audio library current based on trending and popular music and to obtain music and images relevant to the seasons of the year and holidays. The push server 130 communicates with the external source 140 over the Internet. (The direct connection shown is a logical connection.)

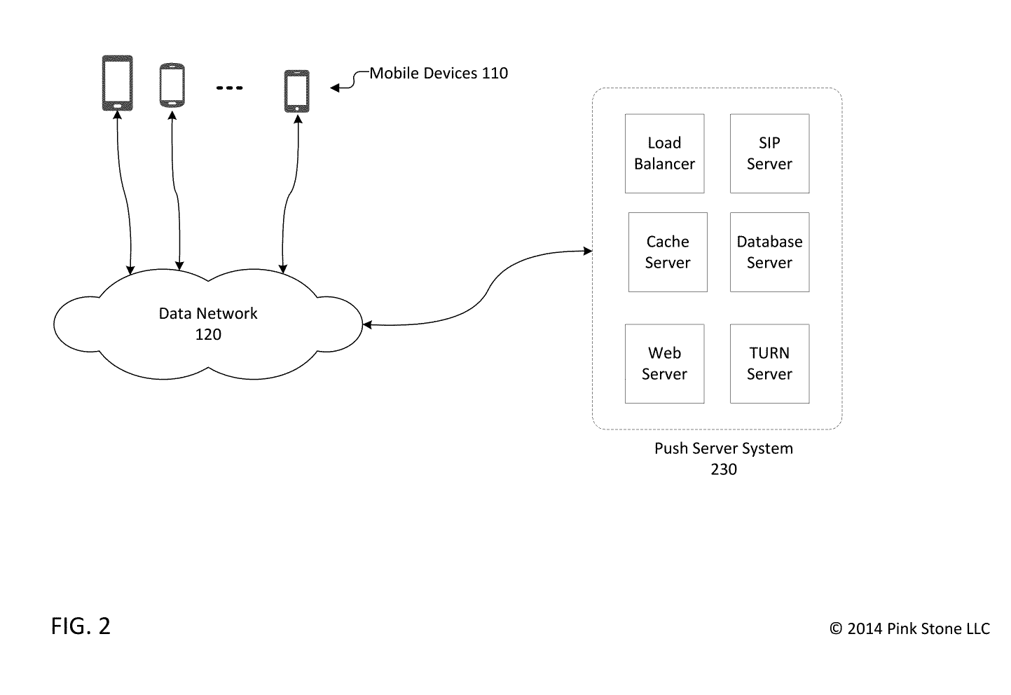

Although shown as a single server in FIG. 1, push server 130 may be a combination of multiple devices including one or more each of servers, switches, multiplexors, load balancers, routers and/or gateways. FIG. 2 is a block diagram of a calling device environment in which the push server 130 is implemented using multiple devices in a push server system 230. The push server system may include one or more of each of some or all of a web server, a SIP server, a database server (which may support the structured query language (SQL) or variants thereof), a TURN (Traversal Using Relay NAT) server, a load balancer (for SIP and/or web), a cache server, a media server, and others. Additional devices such as switches, multiplexors, routers and gateways are not show but may be included as part of the push server system 230.

Method

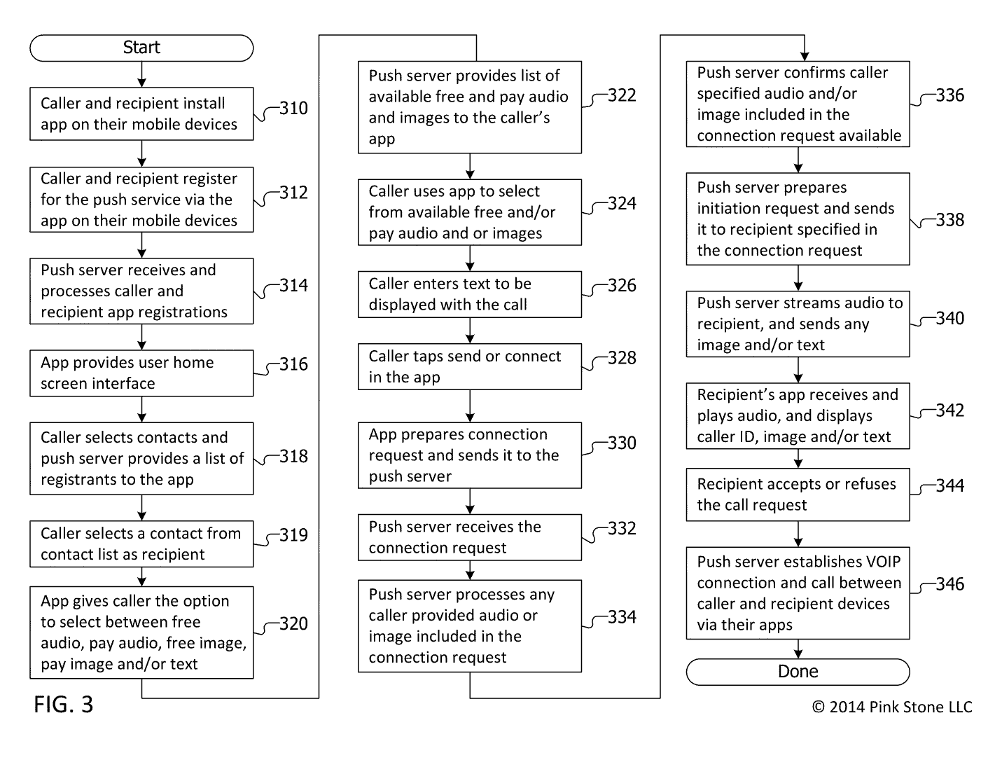

FIG. 3 is a flow chart of a process of mobile communications initiation. Initially, a caller and recipient install an app on their mobile devices, as shown in block 310. This is achieved by the caller and recipient downloading and installing the app from Google's Play store, Apple's App Store, the Amazon Appstore for Android at amazon.com, or other mobile device application sources. When the push service app is installed on a mobile device, a listing of available free and paid audio and images are included. Information about and thumbnails for the audio and images may be provided with the push service app upon install or may be updated or acquired by the push service app later, such as upon initial or later execution of the push service app. Audio files obtained by the push service from an external source are never stored on user mobile devices; that is, the push service app never stores audio files listed in the push service app or received by the push service app. In one embodiment, free ringtones included with the push service app are stored on the user's mobile device in an encrypted formatted.

The caller and recipient register for the push service via the push service app on their mobile devices, as shown in block 312. The registration may be achieved by providing an app user interface that allows a user to choose an account name and an account password. Other user identifying information and/or demographic information may be required to create an account and use the push service app. Agreement to terms of service may be required as a prerequisite to using the push service, and this may be achieved during the registration process by the app providing the user a check box, radio button or other user interface item to signify acceptance to a terms of service provided via the app. The push service app communicates with the push server to confirm the availability of the user name. The push server receives and processes caller and recipient app registrations received from their mobile devices over the data network, as shown in block 314. This may include displaying a welcome or other similar message to the user via the app. During registration, the push service app may enable the user to select an avatar, photo or other image to be associated with the user via the app and sent to the push server as part of the registration process. A user identifying avatar, photo or other image may be selected at a later time or removed or replaced by the user via the app. The actions taken in blocks 310, 312 and 314 are preliminary steps that only need to be performed once.

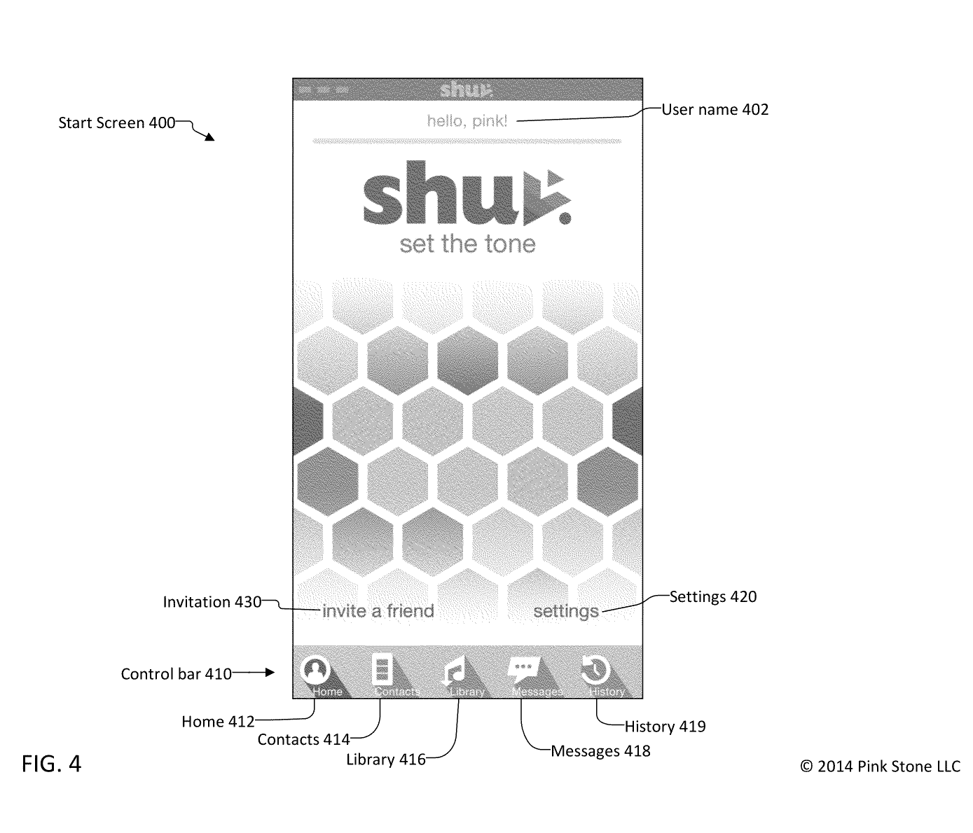

After registration and upon opening the app for regular use, the app provides the user with a start screen or home screen such as that shown in FIG. 4, as shown in block 316. Referring now to FIG. 4 a mobile device screen shot providing a start screen interface 400 is shown. The start screen of the app provides the user the ability to select to perform various actions such as go home to the start screen, invite a friend to use the service, adjust settings, access the user's contact list, access the audio library, access the image library, view/send text messages sent via the app, and view the history of actions taken with the app. In one version of the app, some of the actions are accessible via a control bar area 410 located on the bottom portion of the app while other actions may be access via text links located in the interface. In one version of the app, the control bar 410 includes icons that signify the actions available to the user and enabled by the push service app, including a home icon 412, a contacts icon 414, an audio library icon 416, a messages icon 418 and a history icon 419. The icons in the control bar area 410 may be augmented with text identifying the particular action associated with the icon. The start screen interface 400 may display the user's name 402.

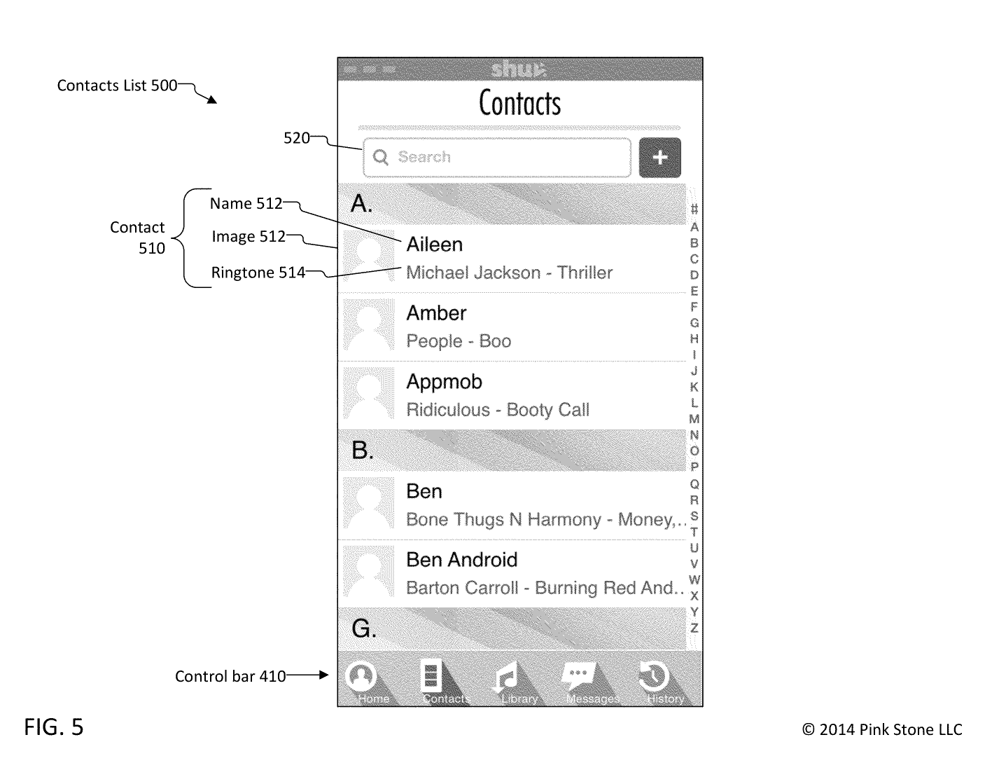

In one version of the push service app, when the caller selects contact 414, the push server provides (or updates) a list of registrants to the app, as shown in block 318, and the app displays a contact list comprised of all registered users like that shown in FIG. 5. Referring now to FIG. 5, a mobile device screen shot 500 showing a contact list is shown. The contact list includes those contacts available to the user. The contact list may include all registered users or only those registered users who are on an app user's selected or preferred list. The contact list contents may be user selectable and configurable via the push service app.

In one version, each contact 510 is displayed showing a user name 512, associated audio or ringtone 514 and a photo, avatar, or other image 512 associated with the contact. In various versions of the push service app, the registered contact and/or the user of the app may select the image associated with the contact. The contact list may be sorted, in various versions, alphabetically by contact name, by ringtone name, and by date of registering. In one version, contact 510 may also include a designation of group membership by displaying an associated icon or associated text. The group the contact is a member of may be selected by the registered contact and/or by the app user. In this way, a single communication may be made to multiple contacts concurrently by selection of a group, such that the same audio is sent to each member of the group concurrently.

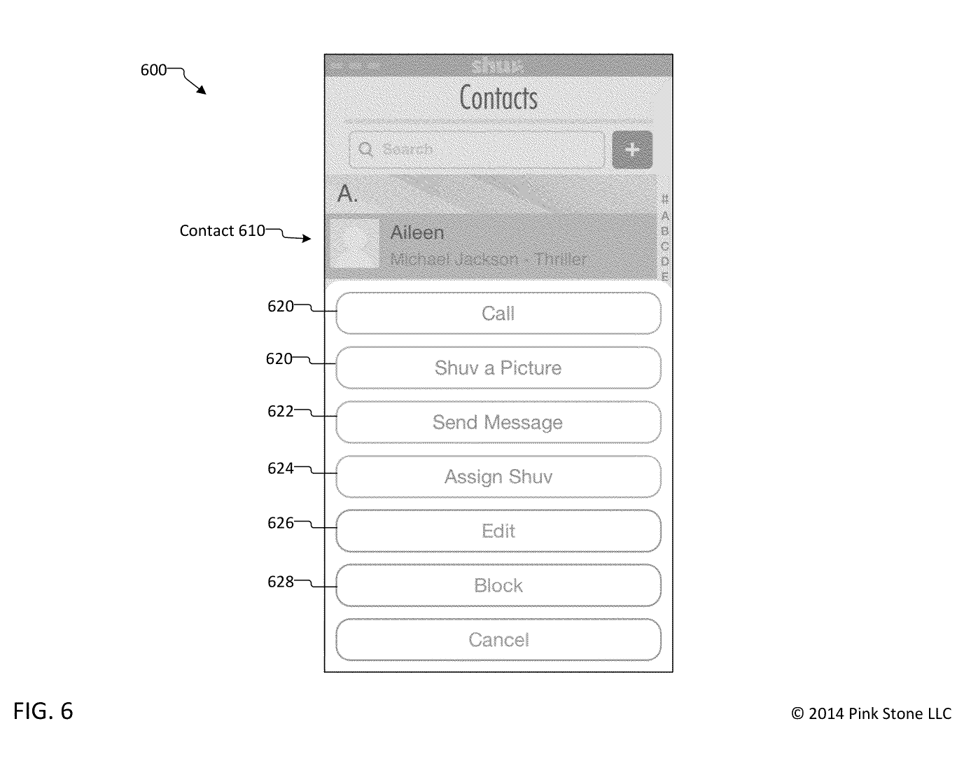

A caller may select a contact to be a recipient via the contact list of the push service app, as shown in block 319. When an app user decides to communicate with a contact using the app, the caller may tap to select a contact to initiate communication with the contact (See FIG. 4). The push service app then displays a contact action screen 600. Referring now to FIG. 6, a mobile device screen shot providing a contact action interface screen 600 is shown. The contact action screen gives the user the ability to and option to select between sending free audio, a pay audio, a free image, a pay image and/or text when initiating a VOIP call with the selected contact, as shown in block 320. The push server provides a list of available free and pay audio and images to the caller's push service app, depending on the user's selection, as shown in block 322. In one embodiment, the push service app may temporarily cache or store versions of some of the audio and images provided to the caller. The caller uses the push service app to select from available free and/or pay audio and or images, as shown in block 324.

In one implementation of the actions described in blocks 320, 322 and 324, referring to FIG. 6, after a user selects a contact 610, the push service app gives the user the option to call 620 the contact, push an image 620 to the contact, assign audio 624 for the contact, edit the contact 626, and block the contact 628. In the example shown in FIG. 6, the audio “Michael Jackson—Thriller” has earlier been assigned to contact “Aileen”. When the user selects call 620, the audio associated with Aileen will be pushed to Aileen via the push server, and an attempt to establish a VOIP call with Aileen will be made by the push server. When the user selects call 620, Aileen's push service app will play the audio on Aileen's mobile device as a precursor to a VOIP call with the caller. The audio is streamed to the recipient via the push server. The audio is not stored on either the caller's mobile device or the recipient's mobile device. In this way the audio provided by the push service can only be used by the push service app. The push service app walls off or otherwise restricts access to audio and images included with the push service app or with a subscription to the push service app. Depending on the implementation and caller selection, nothing, user input text, an album cover or user selected image or the user's photo, avatar or other image may be transmitted with and displayed on the recipient's device when the audio is played on the recipient's device to initiate a VOIP call.

When the user selects to assign audio 624, the push service app may automatically provide a library of available audio (including, in various embodiments, ringtones, song snips or full songs) or give the user the option to record their own custom initial audio greeting. The audio greeting may have a system required time requirement of between, for example 5 and 30 seconds, between 10 and 60 seconds, not longer than a system specified time, not shorter than a system specified time, and the like. In one version of the system the only audio listed by the app is that made available by the push server. That is, in one version of the system, the user is restricted from using the push service to send full length songs obtained from the user's music library. In one version of the system, the user is restricted from using the push service app to obtain and send any audio files available on the user' mobile device or accessible to the user's mobile device. In one version of the system, when the user selects to assign audio 624 to the contact 610, the app provides a user interface to the user that includes an audio library.

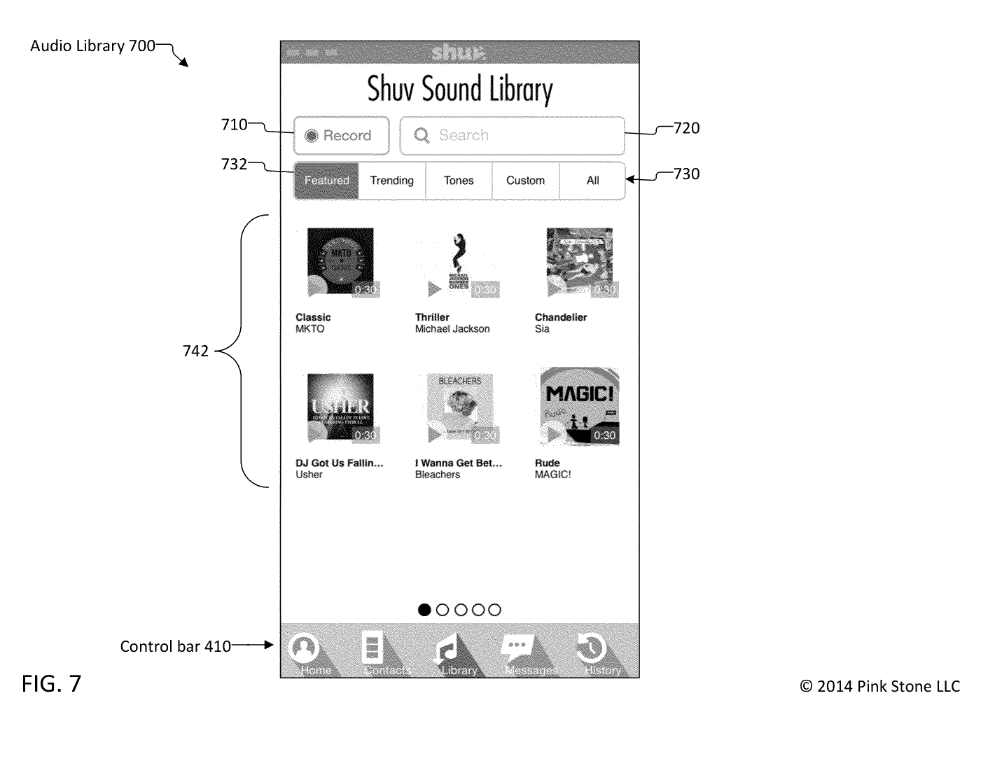

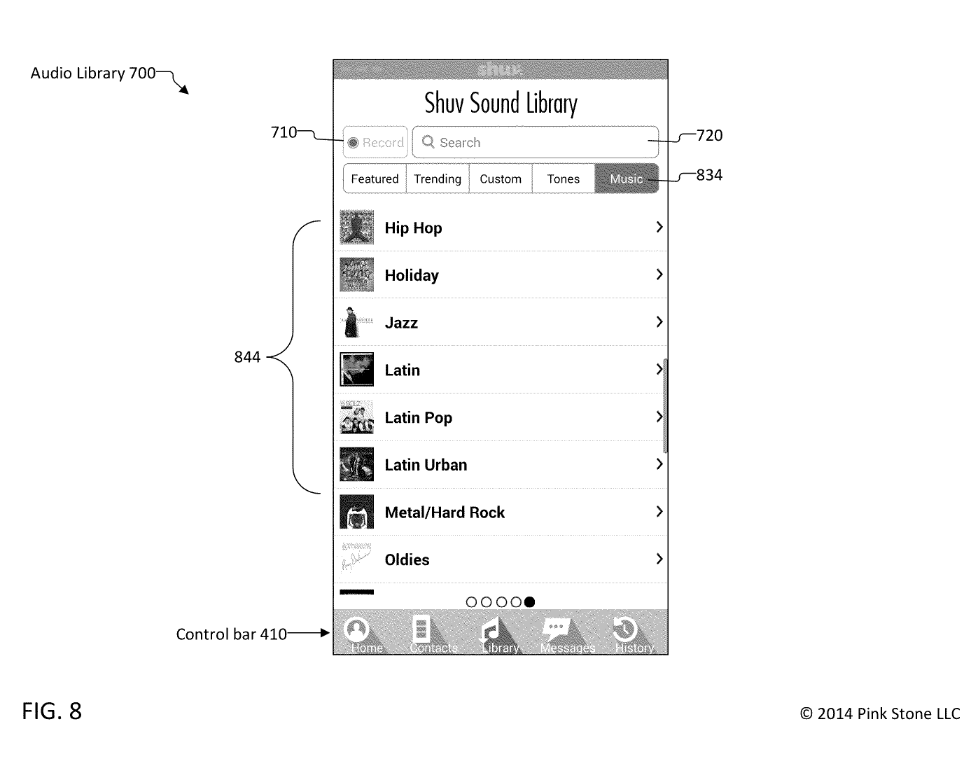

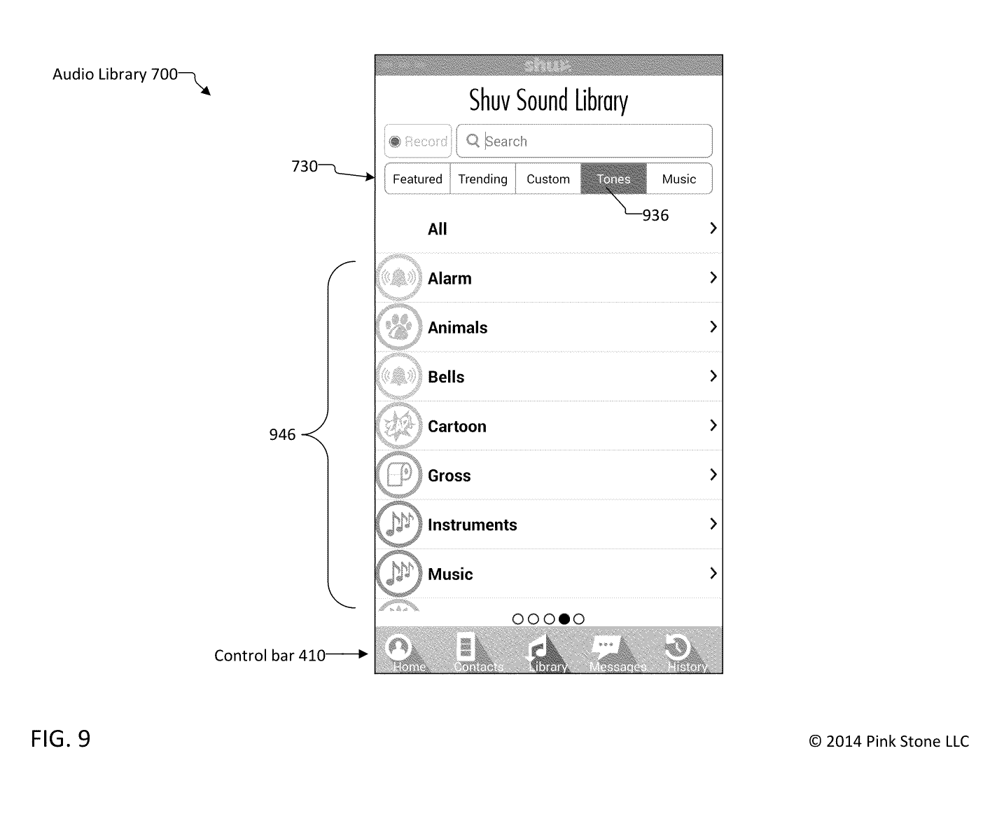

FIGS. 7, 8 and 9 are mobile device screen shots showing an example audio library interface 700. The audio library displays available ringtones and/or audio. The audio library includes free and pay audio. The push service app may allow the user to elect to view subsets of audio items by providing audio ringtone view controls 730. In the example shown in FIGS. 7, 8 and 9 audio view controls 730 provided by the push service app allow the user to elect to view only featured songs (732), trending songs, music (834), tones (934), and custom recordings. When tones or music are selected, subcategories such as genre, price, free, tempo, timbre, etc. may be provided. As shown in FIG. 8, when music 834 is selected from the audio ringtone view controls 730, genres or categories of music 844 are provided, such as, for example, hip hop, jazz, Latin, oldies, metal, etc. As shown in FIG. 9, when tones 936 is selected from the audio ringtone view controls 730, categories or kinds of ringtones 946 may be provided.

The push service app may also provide the ability to search via a text entry box 720 (or pull-down menu or other graphical user interface construct) audio items based on or more criteria including artist, song, genre, etc. The push service app may display the audio library, in various implementations, by name, by artist, by composer, by mood, by genre, by style, etc. The push service app may allow the user to select how the audio will be displayed. The example audio library 742 shown in FIG. 7 includes both graphical representations of the album cover for the song along with text designations of the artist and song. A length of the audio ringtone may also be provided with the audio information. Additional text and/or graphics may be included with each audio item in the library designating, free or pay, the particular genre, a temp, a holiday, a season, and the like.

The push service app may give the user the opportunity to subscribe to various libraries of audio files and image files. The subscription may be monthly, yearly, based on a full library or smaller subset specialty libraries, and may be based on a certain number of ringtones or songs per month or other period. The push service app may provide a number of free audio files and free image files. The push service app may provide the user the opportunity to purchase single audio and image files. A library of audio files may include a certain number of top songs such as top 40 or top 25; a genre library, such as 50's, top country, burning metal, smooth jazz; a seasonal or holiday library, such as Valentine's Day, Christmas, summer fun; and the like. Purchase and payment may be achieved through in-app purchases. The push service app may process purchases according to well-known online payment tools offered through Google Play service, Apple iTunes store, Amazon.com payment service, and other payment service providers.

Referring again to FIG. 3, the push service app may enable a caller to enter text to be displayed with the call, as shown in block 326. This is optional and up to the user.

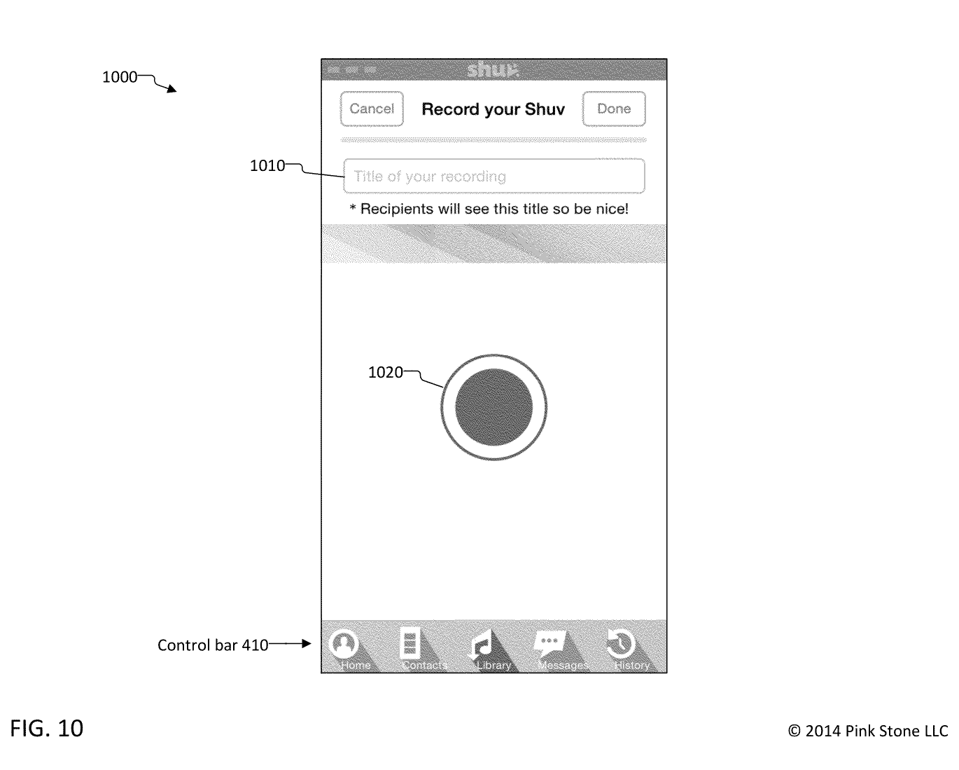

The push service app provides the user the ability to record a greeting or introduction. This is done in the example shown in FIG. 7 by record button 710. When the user elects to record a greeting or introduction by tapping the record button 710, the app displays an audio record interface. Referring now to FIG. 10, a mobile device screen shot of an audio record interface 1000 is shown. In this interface, the push service app allows the user to record an audio snip to be sent to the recipient when the user initiates a call. The user begins recording by accessing the big red button 1020. The push service app allows the user to record a text greeting in a text entry field 1010 that will accompany the audio recording. In one version of the app, a caller recorded custom introduction may be combined with and preceded a ringtone or song snip to initiate a VOIP call. In another version of the app, a caller must select between a recorded custom introduction or a ringtone or song snip to initiate a VOIP call, such that only one can be played to alert the recipient to the VOIP call.

In addition to the push service providing audio to initiate a call from a caller to the recipient, just as the app allowed a user to select from among a variety of songs in an audio library, a variety of images may be provided to the user in the same way. The images may be provided along with the selected audio, in place of an album cover, or with a user recording greeting or introduction. When a user selects send an image 620, shown in FIG. 6, an image library is provided to the user. The images may be sortable and provided by theme, genre, holiday, color scheme, mood, and the like. The images may be licensed and obtained by the push service from third party providers (that is, the external source). The push service app may allow the user to add a text message to accompany the greeting. The push service app allows the user to take a photo using the mobile device's camera and select that image. The app allows a user to select from the photo gallery or image gallery on the mobile device. The audio greeting with selected image may be used in any of a variety of situations such as the user singing happy birthday with an image of a birthday cake; a sad frown-faced image along with a certain selected song to send an apology; an image of a bottle of wine and a rose with a love song; and many, many others. In one version of the push service app, an image pushed from a caller to a recipient alone such that it is not accompanied by any audio.

After the user selects a song or ringtone from the audio library, records audio, selects an image from the image library, takes a photo, and/or inputs text, the VOIP call is initiated with the recipient. Referring again to FIG. 3, the caller taps send or connect in the push service app, as shown in block 328. The push service app prepares a connection request and sends it to the push server. The connection request includes the caller selected audio or audio identifier, image, and/or text along with a recipient designator. When the user selects audio and/or an image from a push service library, an audio identifier and/or an image identifier are included in the connection request. When the caller recorded an audio greeting or introduction, selected a photo or image from the caller's phone, and/or input text, those specific items are included with and sent to the push server as part of the connection request. Preprocessing of user recorded images or audio may be performed by the push service app before transmission to the push server. The push server receives the connection request from the push service app, as shown in block 332. The push server processes any caller provided audio or image included in the connection request, as shown in block 334. The push server confirms caller specified audio and/or image included in the connection request is available, as shown in block 336. This may be done by checking the database on the push server. The push server may check its database to determine whether the recipient has blocked communication attempts from the caller. If so, the push service sends a connection refused notification to the caller's push service app, and the caller's push service app issues an appropriate message or notice to the caller; and the method ends here.

When the recipient has not blocked the caller, the push server prepares a call initiation request and sends it to recipient specified in the connection request, as shown in block 338. Sending the call initiation request is performed concurrently with streaming audio to the recipient device which causes the recipient's push service app to play the streaming audio and display a user name of a user of the caller. The call initiation request may include text and an image file or image identifier along with a caller identifier. The push server streams audio to the recipient, and/or sends any image and/or text, as shown in block 340. The image and any text in the initiation request is displayed and the audio streamed by the push server is played via the app on the recipient's mobile device, as shown in block 342. In one embodiment, the image and any text in the initiation request is displayed or the audio in the initiation request is played via the app on the recipient's mobile device. What is played and presented on the recipient device depend on the kind of device and user settings. The recipient then either accepts or rejects (ignores) the call request, as shown in block 344. In one embodiment, the push service app may give the recipient the option to accept the call once, always accept in addition to refusing the call. While the audio is played and image and text received, accept and refuse call buttons are displayed on the recipient's app. When the recipient accepts the call by tapping the appropriate button, the push server establishes a VOIP connection and VOIP call between the caller and recipient devices via their apps, as shown in block 346.

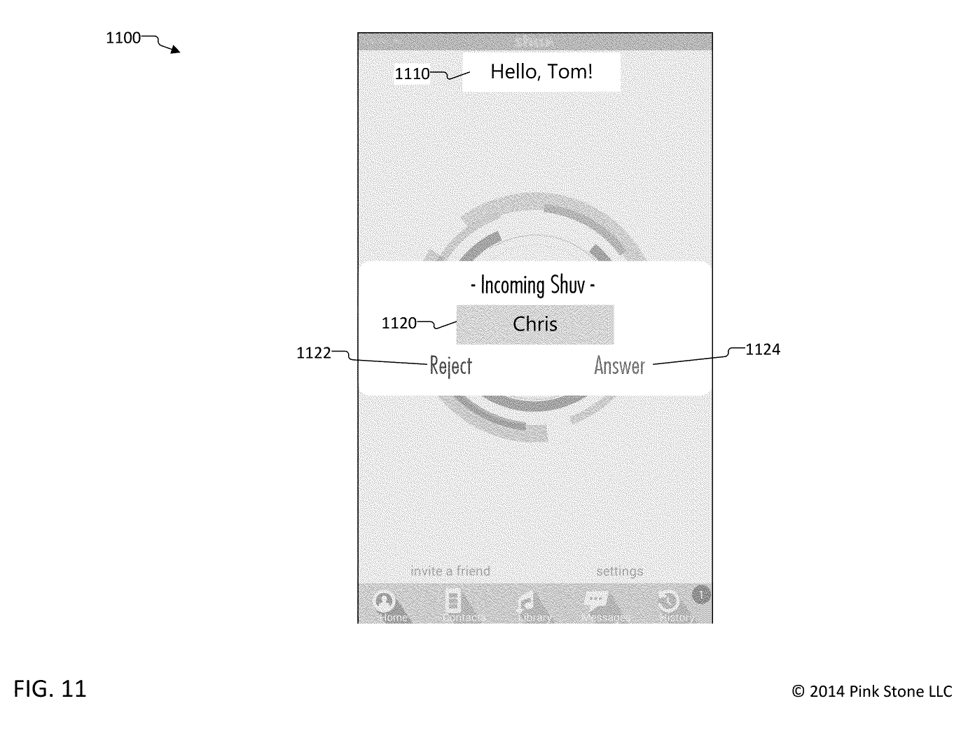

In one embodiment, as shown in FIG. 11, a user interface 1100 on the recipient's device provides the recipient the ability to answer or reject (or accept or refuse) the caller's call while the caller selected audio is being played by the caller's device. The push service app on the recipient's device plays the caller selected audio streamed from the push service server using the hardware (namely the audio speaker(s)) on the recipient's device until the recipient selects reject 1122 or answer 1124 via the user interface 1100. The user name 1120 of the caller may be displayed by the push service app on the recipient device when the caller selected audio is being played. In this example, the name of the recipient 1110 is also displayed.

The push service app is designed so that the recipient's app does not store the audio or image on the recipient's mobile device. This maintains the copyright-based restrictions on the use of the audio and image.

If the recipient is not at the recipient's mobile device, a missed connection request notification will be provided in the recipient's app. Depending on the implementation, the app may be authorized on installation to supersede silent or quiet settings on the recipient device. Depending on the implementation, the app may make settings available to a user to allow the user to elect whether to allow the app to supersede silent or quiet settings on the recipient device for no, all or user selected registered users.

If the call is refused via the recipient's push service app, as shown in block 344, the push server breaks the connection with the app on the recipient device, the push server notifies the app on the caller's mobile device, and the app on the caller's device displays a connection refused message.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention claimed.

It is claimed:

1. A method for Voice Over Internet Protocol (VOIP) call initiation comprising:
receiving a connection request from a caller app on a caller device, the connection request including a recipient identifier and an audio identifier;
sending a call initiation request to a recipient app on a recipient device, the call initiation request including a caller identifier, the sending including streaming audio corresponding to the audio identifier to the recipient device to cause the recipient app on the recipient device to play the streaming audio and concurrently display a user name specified by the caller identifier on the recipient device.

2. The method of claim 1 further comprising:
receiving a call acceptance notification from the recipient app on the recipient device;
establishing a VOIP call between the caller app on the caller device and the recipient app on the recipient device.

3. The method of claim 2 further comprising:
ceasing streaming the audio to the recipient app on the recipient device.

4. The method of claim 1 further comprising:
receiving a call rejection notification from the recipient app on the recipient device;
ceasing streaming the audio to the recipient app on the recipient device.

5. A server computer having instructions stored thereon which when executed cause the server to perform actions comprising:
receiving a Voice Over Internet Protocol (VOIP) call connection request from a caller app on a caller device, the connection request including a recipient identifier and an audio identifier;
sending a call initiation request to a recipient app on a recipient device, the call initiation request including a caller identifier, the sending including streaming audio corresponding to the audio identifier to the recipient device to cause the recipient app on the recipient device to play the streaming audio and concurrently display a user name specified by the caller identifier on the recipient device.

6. The server computer of claim 5 having further instructions stored thereon which when executed cause the server computer to perform additional actions comprising:
receiving a call acceptance notification from the recipient app on the recipient device;
establishing a VOIP call between the caller app on the caller device and the recipient app on the recipient device.

7. The server computer of claim 6 having further instructions store thereon which when executed cause the server computer to perform additional actions:
ceasing streaming the audio to the recipient app on the recipient device.

8. The server computer of claim 5 having further instructions store thereon which when executed cause the server to perform additional actions comprising:
receiving a call rejection notification from the recipient app on the recipient device;
ceasing streaming the audio to the recipient app on the recipient device.
